(19) United States
(12) Patent Application Publication
(10) Pub. No.: US 2014/0210493 A1
(43) Pub. Date: Jul. 31, 2014

(54) HANDHELD AND MOBILE IMPEDANCE SENSOR PLATFORM FOR DETECTION OF E-COLI AND OTHER PATHOGENS WITH IMMOBILIZED PEPTIDE/ANTIBODY

(71) Applicant: Majed El-Dweik, (US)

(72) Inventor: Majed El-Dweik, Jefferson City, MO (US)

(21) Appl. No.: 13/756,242

(22) Filed: Jan. 31, 2013

(51) Int. Cl. G01N 27/02

(52) U.S. Cl. CPC G01N 27/02
USPC 324/693

(57) ABSTRACT

A handheld device to detect pathogens may include a handheld impedance sensor to measure impedance of the pathogen having a socket and a sensing circuit being positioned in the socket to provide the pathogen.

### FIELD OF THE INVENTION

The present invention relates to detectors and more particularly to a detector to detect E-coli, Salmonella and other pathogens.

### BACKGROUND

The detection of pathogens is an important objective for today's biological studies.

The detection of pathogens using current technologies need lab testing carried out, generally at an off-site facility by experienced personnel. The main reasons attributed to this are: 1) the testing equipment is cumbersome, extremely expensive and needs trained personnel to operate 2) the sensors (antibody/enzymatic) degrade because of environmental conditions.

### SUMMARY

A handheld device to detect pathogens may include a handheld impedance sensor to measure impedance of the pathogen having a socket and a sensing circuit being positioned in the socket to provide the pathogen.

The socket may be positioned in the front face of the handheld impedance sensor.

The handheld impedance sensor may include an arm nondestructively detachably connected to restrain the sensing circuit.

The sensing circuit may include a first electrode a and second electrode which may be opposed to the first electrode.

The first electrode may include a first finger and the second electrode includes a second finger to form an array with the first finger.

The first finger may be substantially perpendicular to the first electrode.

The second finger may be substantially perpendicular to the second electrode.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a back view of a handheld impedance sensor of the present invention;

FIG. 2 illustrates a side view of a handheld impedance sensor of the present invention;

FIG. 3 illustrates a front view of the handheld impedance sensor of the present invention;

FIG. 4 illustrates a schematic of the handheld impedance sensor and sensing circuit of the present invention;

FIG. 5 illustrates a schematic of the sensing circuit of the present invention;

FIG. 6 illustrates a schematic of the sensing circuit of the present invention;

FIG. 7 illustrates a schematic of the sensing circuit of the present invention;

FIG. 8 illustrates a schematic of the sensing circuit of the present invention;

FIG. 9 illustrates a cross-sectional view of the sensing circuit of the present invention.

### DETAILED DESCRIPTION

The present invention includes a mobile, handheld impedance measuring system which will be able to replace the conventional table-top measuring test set-up that is used in the detection of E-coli, Salmonella and other pathogens.

The present invention is analogous in use to the glucose sensing of blood sugar in diabetic patients. The present invention is easy to use, cost effective and on-site. The device of the present invention may include a mobile impedance sensor/sensing circuit 103 with immobilized peptide/antibody for detection of specific pathogens in conjunction with instrumentation which may include the handheld impedance sensor 101.

The system of the present invention may include a three part system, namely: 1) the sensing bio-chip/sensing circuit 103 2) the bio-chip holder/socket 113 and 3) the instrumentation/handheld impedance sensor 101 to measure the change in impedance.

A detection system of the present invention may be handheld in order to provide mobility and lightweight. The sensor/sensing circuit 103 may potentially be customized to detect a specific pathogen.

The use of peptides as an alternate to antibody detection mitigates the environmental conditions (Ex: Keeping the antibody refrigerated etc.) that are needed for antibody sensing, that make the antibody sensors redundant on outdoor farm conditions.

The present invention may be sensitive to quantitative analysis for low concentrations of bacteria.

The testing with the present invention can be performed on the same chip/sensing circuit 103 without the need for replacing the bio-chip/sensing circuit 103 for different steps of control, antibody immobilization, antigen bonding and antigen specificity.

The present invention is easy to use.

The cost effectiveness of the present invention will make it possible for it to be owned by individuals, farms, companies and agencies.

FIG. 3 illustrates a front view of the handheld impedance sensor 101 which may include an aperture 107 for a display circuit 109 to display information which may include the results of sensing the sensing circuit 103. Additionally, the handheld impedance sensor 101 may include a multitude of channel selector control switches 105 to control the processor circuit 111 which may be positioned behind the handheld impedance sensor 101. FIG. 3 additionally illustrates a socket 113 to nondestructively detachably connect and retain a sensing circuit 103 which may be defined by a pair of opposing arms 115 to retain and distract and nondestructively detachably connect the sensing circuit 103, and the socket 113 may be a depression within the front surface of the handheld impedance sensor 101. FIG. 3 illustrates apertures 117 for control switches 119 to control the processor 111.

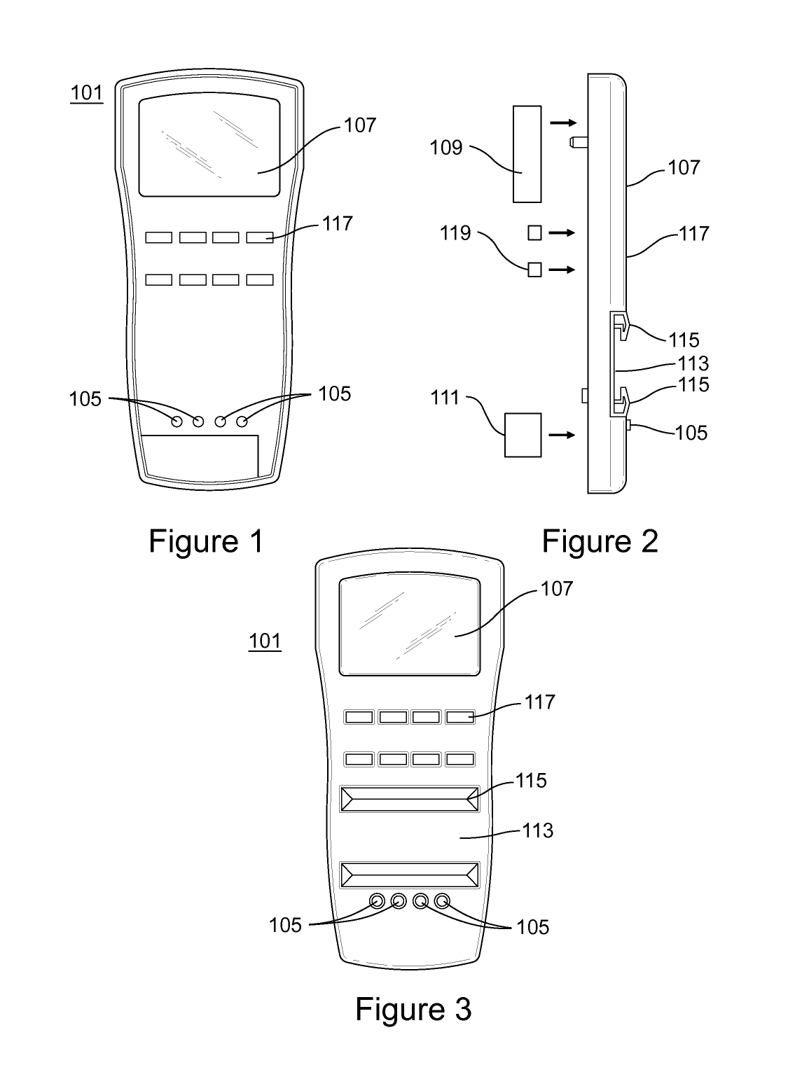

FIG. 1 illustrates a back view of the handheld impedance sensor 101 which may include an aperture 107 for a display circuit 109 to display information which may include the results of sensing the sensing circuit 103. Additionally, the handheld impedance sensor 101 may include a multitude of channel selector control switches 105 to control the processor circuit 111 which may be positioned behind the handheld impedance sensor 101. FIG. 1 illustrates apertures 117 for control switches 119 to control the processor 111.

FIG. 2 illustrates a side view of the handheld impedance sensor 101 which may include an aperture 107 for a display circuit 109 to display information which may include the results of sensing the sensing circuit 103. Additionally, the handheld impedance sensor 101 may include a multitude of channel selector control switches 105 to control the processor circuit 111 which may be positioned behind the handheld impedance sensor 101. FIG. 2 additionally illustrates a socket 113 to retain a sensing circuit 103 which may be defined by a pair of opposing arms 115 to retain the sensing circuit 103. FIG. 2 illustrates apertures 117 for control switches 119 to control the processor 111.

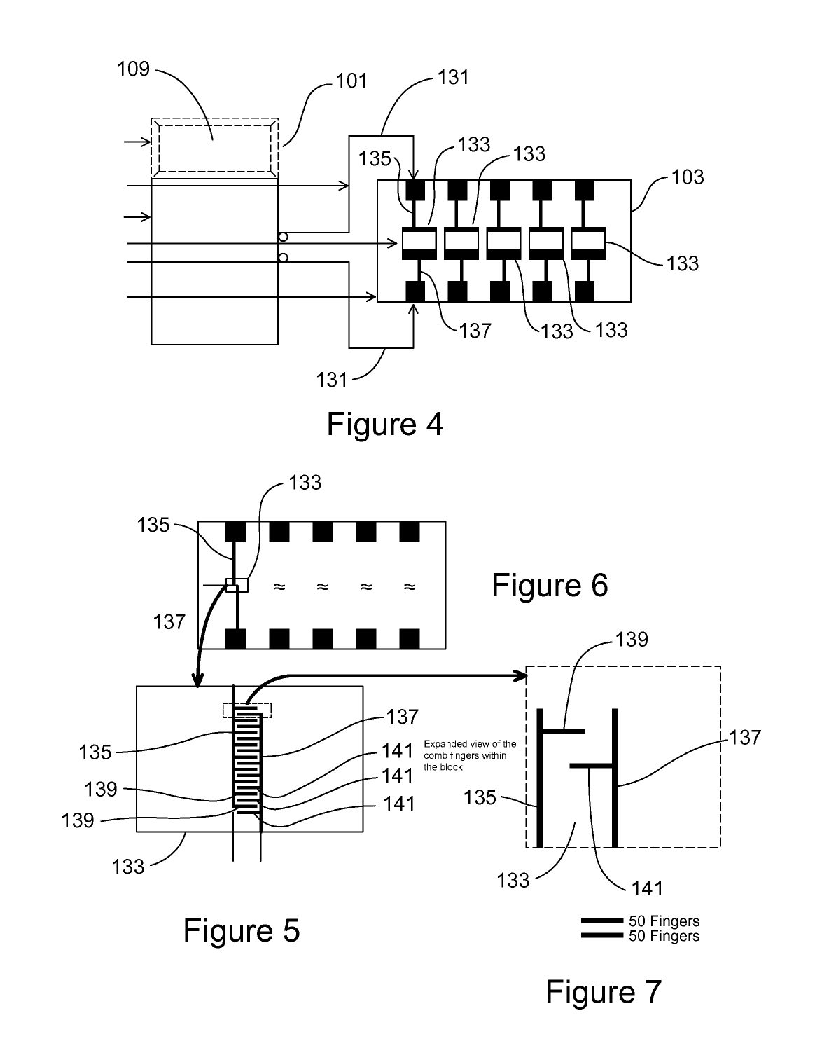

FIG. 4 illustrates a schematic diagram of the handheld impedance sensor 101 and the sensing circuit 103 which may be a biochip, and the handheld impedance sensor includes a display circuit 109 to display information obtained from the sensing circuit 103 and may be connected to connecting wires 131 to connect the sensing circuit 103 to the handheld impedance sensor 101.

The handheld impedance sensor 101 may transmit a sensing signal to the sensing circuit 103 through a first connecting wire 131 and the sensing signal is transmitted through the sensing circuit 103 more particularly to a sample reservoir 133 at a first electrode 135 and the signal transmitted through the sample reservoir 133 and received by the second electrode 137 and transmitted to the handheld impedance sensor 101. The handheld impedance sensor 101 measures the impedance (magnitude and phase) between the first electrode 135 and the second electrode 137 and measures a phase difference resulting from the material within the sample reservoir 133. The result of the measurement may be displayed on the display circuit 109.

While the handheld impedance sensor 101 and the sensing circuit 103 are shown separately, the sensing circuit 103 may be positioned within the socket 113 and may be secured by the arms 115.

The sensing circuit 103 as shown in FIG. 4 may include a reservoir 133 to hold samples for example the above mention pathogens in order to identify the presence and type of pathogen present in the reservoir 103. The sensing circuit 103 may include a first electrode 135 and a second electrode 137, and the first electrode 135 may be opposed to the second electrode 137 with respect to the sample reserve 133 and may overlap and may be staggered with the second electrode 137.

The sensing circuit 103 as shown in FIG. 5 may include a reservoir 133 to hold samples for example the above mention pathogens in order to identify the presence and type of pathogen present in the reservoir 103. The sensing circuit 103 may include a first electrode 135 and a second electrode 137, and the first electrode 135 may be opposed to the second electrode 137 with respect to the sample reserve 133 and may overlap and may be staggered with the second electrode 137.

The sensing circuit 103 as shown in FIG. 5 may include a reservoir 133 to hold samples for example the above mention pathogens in order to identify the presence and type of pathogen present in the reservoir 103. The sensing circuit 103 may include a first electrode 135 and a second electrode 137, and the first electrode 135 may be opposed to the second electrode 137 with respect to the sample reserve 133 and may overlap and may be staggered with the second electrode 137.

FIG. 5 additionally illustrates that the first electrode 135 may include a first finger 139 which may extend substantially perpendicular to the first electrode 135, and the second electrode 137 may include a second finger 141 which may extend substantially perpendicular to the second electrode 137. A multitude of first fingers 139 and second fingers 141 may form an array or mesh of alternating first finger 139 and second finger 141.

FIG. 6 illustrates that the first electrode 135 may include a first finger 139 which may extend substantially perpendicular to the first electrode 135, and the second electrode 137 may include a second finger 141 which may extend substantially perpendicular to the second electrode 137. A multitude of first fingers 139 and second fingers 141 may form an array or mesh of alternating first finger 139 and second finger 141.

FIG. 7 illustrates that the first electrode 135 may include a first finger 139 which may extend substantially perpendicular to the first electrode 135, and the second electrode 137 may include a second finger 141 which may extend substantially perpendicular to the second electrode 137. A multitude of first fingers 139 and second fingers 141 may form an array or mesh of alternating first finger 139 and second finger 141.

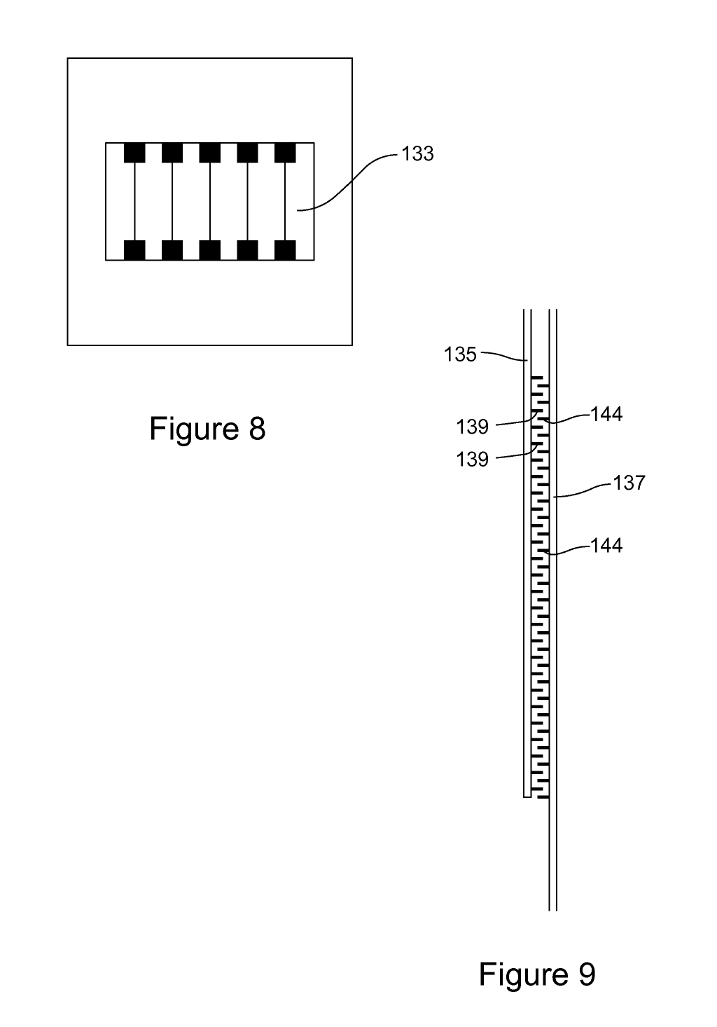

FIG. 8 illustrates a schematic of the sensing circuit of the present invention and illustrates the sample reserve 133.

FIG. 9 illustrates a cross-sectional view of the sensing circuit of the present invention and illustrates the first electrode 135, the first finger 139, the second electrode 137 and the second finger 141.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A handheld device to detect pathogens, comprising:
a handheld impedance sensor to measure impedance of the pathogen having a socket;
a sensing circuit being positioned in the socket to provide the pathogen.

2. A handheld device to detect pathogens as in claim 1, wherein the socket is positioned in the front face of the handheld impedance sensor.

3. A handheld device to detect pathogens as in claim 1, wherein the handheld impedance sensor includes an arm nondestructively detachably connected to restrain the sensing circuit.

4. A handheld device to detect pathogens as in claim 1, wherein the sensing circuit includes a first electrode a and second electrode which may be opposed to the first electrode.

5. A handheld device to detect pathogens as in claim 4, wherein the first electrode includes a first finger and the second electrode includes a second finger to form an array with the first finger.

6. A handheld device to detect pathogens as in claim 5, wherein the first finger is substantially perpendicular to the first electrode.

7. A handheld device to detect pathogens as in claim 5, wherein the second finger is substantially perpendicular to the second electrode.
